(19) United States
(12) Patent Application Publication
(10) Pub. No.: US 2014/0154533 A1
(43) Pub. Date: Jun. 5, 2014

(54) ELECTROCHEMICAL CELL

(71) Applicant: Li-Tec Battery GmbH, Kamenz (DE)

(72) Inventors: Tim Schaefer, Harztor (DE); Denny Thiemig, Moritzburg (DE)

(73) Assignee: Li-Tec Battery GmbH, Kamenz (DE)

(21) Appl. No.: 14/087,628

(22) Filed: Nov. 22, 2013

Related U.S. Application Data
(60) Provisional application No. 61/729,436, filed on Nov. 23, 2012.

(30) Foreign Application Priority Data
Nov. 23, 2012 (DE) 10 2012 022 969.0

(51) Int. Cl. H01M 10/42

(52) U.S. Cl. CPC H01M 10/4235
USPC 429/50; 429/61; 29/623.1

(57) ABSTRACT

An electrochemical cell comprises at least one negative electrode including at least one material which is capable of absorbing charge carrier; at least one positive electrode including at least one material capable of releasing charge carrier; at least one electrolyte capable of transporting charge carrier, between the electrodes; and at least one protective device that is substantially an integral part in at least one of the electrodes and comprises at least one enclosure, the at least one protective device being designed such that if a damaging influence damaging the electrochemical cell occurs, in particular heat, at least one stabilizing additive is released from inside the enclosure.

### CROSS-REFERENCE TO RELATED APPLICATIONS

The present application claims the benefit of U.S. Provisional Patent Application Ser. No. 61/729,436, filed Nov. 23, 2012, the entire content of which is incorporated herein by reference. The present application also claims priority to German Patent Application 10 2012 022 969.0, filed Nov. 23, 2012, the entire content of which is incorporated herein by reference.

### DESCRIPTION

The present invention relates to an electrochemical cell, wherein the cell comprises at least one positive, one negative electrode and a protective device, wherein that protective device is an integral part of at least one electrode and releases at least one stabilizing additive which can antagonize the damages of the cell, in particular of the electrodes, if a damaging influence occurs. Preferably, the cell can be used for driving a vehicle having an electric motor, preferably with hybrid drive or in “plug-in” operation.

Electrochemical cells, in particular lithium secondary batteries, are used as energy storage due to their high energy density and high capacity in mobile information equipment such as mobiles, in tools or in electrically driven cars as well as in cars having hybrid drive. In particular if used in lithium ion batteries for driving a car having an electric motor, in particular with hybrid drive or in “plug-in” operation developments still have to take place in order that the batteries fulfill the following important criteria: high specific power having, at the same time, high power density, high cycle life time and calendric life time, guarantee of the battery safety in case of damage (e.g. in case of short circuit or over load) and costs for material and manufacturing being as low as possible. To achieve these aims further material innovations, functionalizing of known materials, development of new materials and new design-ins are in the focus of development works.

In particular the durability of electrochemical cells is frequently dependent on the aging of the electrodes. When aging, the electrochemical cells i. a. loose capacity and performance. Said process takes place in the most used electrochemical cells to a more or less high extent, and is dependent on the application circumstances (temperature, storage conditions, state of charge, etc.), however, also on the quality and processing of the materials during the manufacturing process of the electrochemical cell. Thus, a high quality processing of pure material may result in durable electrochemical cells, which do not age over a longer period of time, thus only loose comparatively little capacity and performance.

However, such measures are often not sufficient in order to obtain a durable electrochemical cell, as during operation of a cell damaging influences, like too much heat development or entrance of humidity, can start chemical reactions, which in term can lead to a damage of the cell, in particular of the electrode material, which can lead to a loss of capacity up to a largely destruction of the cell.

Thus, for example, it can happen that humidity gets into the interior of the electrochemical cell and results, together with LiPF₆, which is often used as conducting salt in the electrolyte, in the formation of HF (“hydrofluoric acid”), which is not only a safety risk with regard to the toxic properties of HF, if HF leaks from the defect cell, but can also lead to a damage of the electrode material due to reactions with HF.

Furthermore, in case of an over load of the cell, which contains carbon containing active material, this can lead to a decomposition of the SEI layer (SEI=“solid electrolyte interface”), which is formed during initial charging and discharging cycles, in particular on carbon containing active material of the negative electrode. The SEI layer is an important part of a cell, since it not only contributes to the safety of a cell by hampering, if not even preventing the growth of lithium dendrites. So, it can happen, that in particular due to a crack formation within the SEI layer, lithium dendrites can grow through the cracks, respectively pores, which may lead to a short circuit of the cell.

Therefore, a non-negligible effort is made to obtain a SEI layer which is as stable as possible. In the publication US 2009/0106970 A, for example a six step method for producing a lithium-ion battery comprising a SEI layer is described.

One object of the present invention is thus to provide an electrochemical cell, which meets increased safety requirements.

This is achieved according to the invention by means of the teaching of the independent claims. Preferred embodiments of the invention are subject of the dependent claims.

The underlying object is solved by an electrochemical cell designed to provide at least occasionally electrical energy, wherein the electrochemical cell comprises at least one negative electrode, wherein the negative electrode comprises at least one material which is capable of absorbing charge carrier, in particular lithium ions during charge processes; wherein the electrochemical cell further comprises at least one positive electrode, wherein the positive electrode comprises at least one material which is capable of releasing charge carrier, in particular lithium ions during charge processes; wherein the electrochemical cell further comprises at least one electrolyte, which is capable of transporting charge carrier, in particular lithium ions, between the electrodes; and wherein the electrochemical cell further comprises at least one protective device, wherein the protective device preferably comprises at least one storage container, preferably designed as microcapsule, wherein the protective device is substantially an integral part in at least one of the components of the electrochemical cell, in particular of the electrodes, and comprises at least one enclosure, wherein the at least one protective device is designed such that if a damaging influence damaging the electrochemical cell occurs, in particular heat, at least one stabilizing additive, preferably a chemical stabilizing additive is set free from inside the enclosure, wherein the stabilizing additive, preferably a chemical stabilizing additive, is preferably designed such that it antagonizes at least partly that one damage of the electrochemical cell, in particular the electrodes.

An advantage of the electrochemical cell according to the invention is that by using at least one protective device, the at least one stabilizing additive is released only in need, in particular if the electrochemical cell is exposed to a damaging influence, and thus is not destroyed previously, for example, due to undesirable chemical and/or physical processes during operation of the electrochemical cell, and thus is not available in case of need or not in sufficient quantities.

A further advantage of the electrochemical cell according to the invention is, that the protective device is substantially an integral part of at least one component of the electrochemical cell, preferably of at least one electrode, which in turn, leads to an electrochemical cell which becomes safer, as the stabilizing additive in case of a damaging influence is released exactly there, where the stabilizing additive is needed, preferably and exemplarily in the electrodes.

In one embodiment of the electrochemical cell according to the invention the enclosure of the protective device comprises carbon containing material, preferably selected from crystalline or amorphous carbon, in particular graphite, carbon black, graphene or mixtures thereof.

This has the advantage that the protective device can function as conductive additive in at least one component of the electrochemical cell, which is designed in this embodiment preferably as electrode, and thus contributes to the improvement of the electrical conductivity of the at least one electrode.

In one embodiment of the electrochemical cell according to the invention, the enclosure of the protective device comprises a polymeric material, in particular selected from thermoplastic polymers, in particular polyalkylene- or polyolefine based polymers.

This has the advantage that the stabilizing additive can be released easily, in particular due to at least partly melting of the enclosure. The enclosure itself contributes in this embodiment to the increasing of the safety of the cell, since the melted enclosure can place itself protective film like onto the electrode material which is in proximity to the protective device, and thus can reduce, preferably inhibit the charge carrier transport, in particular the lithium ion transport from, respectively into the electrode material, comparable to reaching the “melt down” temperature of a polyalkylene- or polyolefine based separator, wherein by melting down of the pores if a determined temperature is exceeded, the passage of lithium ions is prevented. In contrast to the “melt down” mechanism known from the separator and “deactivating” the whole electrochemical cell, this embodiment has the advantage that only “local” effect is aim for.

In one embodiment of the electrochemical cell according to the invention, the enclosure of the protective device encloses the at least one stabilizing additive, which is in particular selected from vinylene carbonate, PCM or polysulfide.

In one embodiment of the electrochemical cell according to the invention the negative electrode comprises at least partly an electrochemically active material which is selected from amorphous graphite, crystalline graphite, graphene, carbon containing materials, lithium metal, lithium metal alloys, titanates, silicates, silicium, silicium alloys, tin, tin alloys, or mixtures thereof.

In one embodiment the positive electrode comprises at least partly an electrochemically active material, which is selected from:
a) at least one compound LiMPO4, wherein M is at least one transition metal cation, in particular selected from manganese, iron, cobalt, titanium, or a combination thereof; or
b) at least one lithium metal oxide or lithium metal mixed oxide in the crystal structure of spinel type, wherein the metal is in particular selected from cobalt, manganese or nickel; or
c) at least one lithium metal oxide or lithium metal mixed oxide in a crystal structure which is different from spinel type, wherein the metal is in particular selected from cobalt, manganese or nickel; or
d) at least one sulfur compound, in particular elemental sulfur or a sulfide, in particular a metal sulfide or a metal polysulfide, wherein the metal is in particular iron;
   or mixtures thereof.

A method according to the invention for manufacturing an electrochemical cell according to the invention comprises the steps:
providing at least one negative electrode, wherein the negative electrode comprises at least one material, which is capable of absorbing charge carrier, in particular lithium ions, during charge processes;
providing at least one positive electrode, wherein the positive electrode comprises at least one material which is capable of releasing charge carrier, in particular lithium ions, during charge processes;
providing at least one electrolyte, which is capable of transporting charge carrier, in particular lithium ions, between the electrodes;
providing at least one protective device, wherein the protective device preferably comprises at least one storage container, preferably designed as microcapsule,
assembling the electrochemical cell,
   wherein the protective device is substantially an integral part in at least one of the components of the electrochemical cell, in particular of the electrodes, and comprises at least one enclosure,
   wherein the at least one protective device is designed such that if a damaging influence damaging the electrochemical cell occurs, in particular heat, at least one stabilizing additive, preferably a chemical stabilizing additive is set free from inside the enclosure,
   wherein the stabilizing additive, preferably a chemical stabilizing additive, is preferably designed such that it antagonizes at least partly that one damage of the electrochemical cell, in particular the electrodes.

The electrochemical cell according to the invention can be used, according to the invention, for energy supply of a load, in particular in mobile information equipment, tools, electrically driven cars or cars having hybrid drive or a SLi automotive (SLi=starting light ignition) or in aviation, aerospace, shipping or railed vehicles or stationary energy storing devices.

### Electrochemical Cell

Under an “electrochemical cell” in the sense of the invention is to be understood as a device designes in particular for storage of electrical energy. In particular under an “electrochemical cell” in the sense of the present invention is to be understood as electrochemical cells of the primary or secondary type, however, also other forms of energy storages such as, for example, capacitors.

In a preferred embodiment, the electrochemical cell is designed as lithium ion cell.

In a further embodiment, the electrochemical cell is designed as metal-air cell, preferably as lithium metal- or lithium alloy air cell.

In a preferred embodiment, the electrochemical cell comprises cell components, in particular selected from: at least one positive electrode, at least one negative electrode, at least one electrolyte and at least one separator which separates the positive from the negative electrode and wherein these cell components are at least partly surrounded by a housing.

Under “cell component” in the sense of the invention, a device is to be understood, which is in particular a part of the electrochemical cell, in particular selected from at least one negative electrode, at least one positive electrode, at least one electrolyte and/or at least one separator. “Cell component” and “component of the electrochemical cell” can be used interchangeably.

### Damaging Influence/Damage

Under a “damaging influence” in the sense of the present invention is at least one influence to be understood, which is in particular capable of causing at least a damage, which means an at least partly not irreversible reduction of a performance parameter like capacity, energy content, output, output voltage etc. of an electrochemical cell, in particular of the electrodes. A damaging influence in the sense of the invention is in particular present, if at least one determined parameter is reached or exceeded or fallen below. Such a parameter is in particular selected from temperature, temperature range, pressure, pressure range, pH value, pH value range, charging and/or discharging voltage, charging and/or discharging voltage range, charging and/or discharging current, charging and/or discharging current range, water content, in particular increase of the water content.

The at least one damaging influence can impact the electrochemical cell, in particular the cell components of the electrochemical cell, in particular the electrodes and/or the at least one electrolyte and/or the separator from outside, which means from the proximity outside the housing of the electrochemical cell and thus provoke at least one damage of the electrochemical cell, in particular of the electrodes.

The at least one damaging influence can also impact the electrochemical cell, in particular the cell components of the electrochemical cell, in particular the electrodes and/or the at least one electrolyte and/or the separator from the inside, which means within the housing of the electrochemical cell, and thus provoke at least one damage of the electrochemical cell, in particular of the electrodes.

However, it is also possible that at least one damaging influence from outside, which means from the proximity out the housing of the electrochemical cell, impacts the electrochemical cell, in particular the cell components of the electrochemical cell, in particular the electrodes and/or the at least one electrolyte and/or the separator, and at least one further damaging influence from inside, which means within the housing of the electrochemical cell, impacts the electrochemical cell, in particular the cell components of the electrochemical cell, in particular the electrodes and/or the at least one electrolyte and/or the separator.

The damages which are generated by the damaging influence can be manifold and depending on the respective used materials in the cell components, in particular in the electrodes and/or electrolyte and/or separator.

For example, it is possible that the conducting salts LiPF₆ in the electrolyte comes into contact with humidity, in particular with H₂O, resulting in the formation of HF (“hydrofluoric acid”). HF, however, can, on the one hand increase the pressure within the housing of the electrochemical cell, since HF can outgas from the electrolyte solution. On the other hand, HF can participate in undesired reaction with the materials contained in the electrodes, in particular with the contained electrochemically active materials, and thereby damage them.

Furthermore, it is, for example, possible that charging and/or discharging cycles are conducted in a wrong way, which can lead to a release of oxygen from the electrochemically active material of the positive electrode. The formed oxygen can increase on the one hand the pressure within the housing of the electrochemical cell and, on the other hand, can react with the electrolyte, which further leads to a temperature increase within the cell and even up to ignition of the electrolyte.

However, it is also possible, for example, that under regular respectively normal operating conditions a lithium dendrite growths can occur, for example during charging and discharging cycles, in particular at the negative electrodes, in particular in case of a lithium metal anode. If such a dendrite comes into contact with the positive electrode, this can then result in an internal short circuit of the electrochemical cell, which can lead to an explosion of the electrochemical cell.

Furthermore, it is possible that the electrochemical cell is stored at wrong temperatures, in particular at too high temperatures. This can lead to a “bleeding” of transition metals, for example manganese, from the electrochemically active material of the positive electrode into the electrolyte, which is then during the operation of the electrochemical cell disposed on the anode and forms then there a layer, which increases the resistance of the cell.

Furthermore, it is possible that at too high temperatures or during discharging of the cell the SEI layer (SEI=solid electrolyte interface), in particular on the surface of the negative electrode, in particular on a carbon containing negative electrode, is at least partly damaged, respectively decomposed. At these points, where the SEI-layer is damaged respectively decomposed, the electrolyte can react with the active material, whereby electrolyte and/or active material are degraded. Furthermore, at these points where the SEI-layer is damaged, respectively decomposed, the not desired lithium dendrite growth can be facilitated and it thus can result in an short circuit and an explosion of the cell. Furthermore, it is possible that the electrolyte is decomposed, which then can lead to a gas development.

In one embodiment, “damaging influences” in the sense of the present invention can lead to a damage of the cell components, in particular of the electrodes and/or the electrolyte, in particular then if, due to the damaging influence, in particular the formation and/or entrance of water, oxygen, HF, CO₂, CO, lithium dendrite growth, damage of the SEI-layer(s) or transfer of electrochemical active material of at least one electrode into the electrolyte, can occur.

Furthermore, it is possible that the damaging influence leads to the formation of cracks within a material of the electrochemical cell, in particular within at least one electrode or the damaging influence leads to an at least partly delamination of cell components from each other. Therefore, it is possible that the electrons and/or lithium ion migration is negatively influenced, in particular hampered. This, in turn, can result in an increased resistance within the electrochemical cell, which negatively influences the performance of the electrochemical cell. In particular, if the electrochemically active material of an electrode is at least partly delaminated from the separator layer or from the metallic substrate, in particular from the collector, this has negative consequences on the performance of the electrochemical cell.

A relation between the damaging influence and the damage of the electrochemical cell, in particular of the cell components, in particular of the electrodes and/or electrolyte follows the “cause-consequence-effect”-principle (“Ursache-Folge-Wirkung”-Prinzip).

The damaging influence, for example an increase of the humidity content, in particular water, has the consequence that, due to the reaction of LiPF₆ and water, the formation of HF occurs, which can effect a damage of the electrodes, in turn. A damaging influence can also have two or more consequences and thus can effect two or more damages. The damaging influence can thus be causally associated with at least one damage.

The damage of the electrochemical cell, in particular of the cell components, can inter alia result in that the capacity of the cell decreases and/or the cell is not save any more and cannot be operated normally any more.

Therefore, it is advantageous to take protection measures, which at first preclude that a damaging influence does not occur at all.

This can, for example, be achieved by cooling measures, which cool the electrochemical cell, if the cell is exposed to too high temperatures, or develops too high temperatures, or, for example, by electrical measures, like the connection of an electrochemical cell to an overcharge protection, which, for example, disconnects the supply of electrical energy during the charging process, if an overload of the cell is immanent.

However, such protection measures are partly not sufficient, that is why in the sense of the present invention a protection measure within the cell is necessary, which antagonizes damages of the electrochemical cell, in particular of the components, preferably repairs them.

Such protection measures in the sense of the present invention are based on physical and/or chemical processes and/or reactions and relate to a protective device, preferably comprising a stabilizing additive, which is particularly advantageous, since the effect of the stabilizing additive develops after the occurrence of a damaging influence, respectively after occurrence of the damage of the electrochemical cell, in particular of the cell components, in particular of the electrodes and/or the electrolyte.

### Protective Device

Under a “protective device” according to the present invention at least one device is to be understood, which is designed such that the device undergoes a change if a damaging influence of the electrochemical cell occurs, wherein the change contributes to protect the electrochemical cell, in particular the cell components, in particular the electrodes and/or the electrolyte against the damaging influence and/or antagonizes the damaging influence.

Under “change” (“Umwandlung”) in the sense of the present invention a change is to be understood of a first chemical and/or physical condition of the protective device into a second chemical and/or physical condition, wherein this second condition differs from the first chemical and/or physical condition, wherein the chemical composition of the protective device can change, thus, the chemical condition of the protective device can change and/or the protective device can change its state of aggregation, thus the physical condition changes.

This change can be reversible or irreversible.

A change of the chemical condition of the protective device from a first chemical condition into a second chemical condition can, in particular, occur then, if the protective device is designed such that damaging compounds like, for example, water or HF, are at least partly absorbed from the protective device and preferably incorporated into the protective device, and/or absorbed by the protective device and changed by chemical reaction(s). A change of the chemical condition of the protective device is, in particular, present, if a first chemical composition of the protective device or of a part of the protective device differs from a second chemical composition of the protective device or or a part of the protective device, which can preferably and exemplarily occur by absorption and/or release and/or reaction of respectively with damaging neutral and/or ionic and/or radical atoms, in particular protons and/or damaging neutral and/or ionic and/or radical molecules or macromolecules, in particular water, oxygen, HF, CO₂, CO.

A change of the physical condition of the protective device from a first physical condition into a second physical condition occurs, in particular, then if the protective device or a part of the protective device changes its state of aggregation, in particular from solid to liquid or liquid to solid, or solid to gaseous or liquid to gaseous.

The design of the protective device as storage container for at least one stabilizing additive, wherein the stabilizing additive is part of the protective device, is particularly advantageous.

In one embodiment the at least one protective device is designed as storage container, further preferred as at least one micro capsule.

According to the present invention, under the term “protective” device it has not to be understood a device necessarily, but, in particular, also a substance or a material component, which is similar preferably to the components of an electrode, in particular the active material, with respect to size and manifestation.

The advantage of this at least one protective device is that the at least one stabilizing additive is released only in need, in particular if the electrochemical cell is exposed to a damaging influence, respectively if a damage is occurred, and thus, the stabilizing additive is not destroyed previously, for example due to undesirable chemical and/or physical processes during operation of the electrochemical cell, and thus is not available in case of need or not in sufficient quantities, for example if a damaging influence occurs. This contributes to the improvement of the safety of the electrochemical cell.

The at least one protective device In the sense of the present invention is substantially an integral part or constituent (Bestandteil) or at least one cell component, in particular of at least one electrode and/or electrolyte and/or separator.

It is particularly advantageous, if the at least one protective device is substantially an integral part or constituent of at least one of the electrodes

This is, in particular, an advantage, since, if a damaging influence, respectively a damage occurs, the stabilizing additive is, in particular, released there, where the stabilizing additive should prevent the at least one damage or should antagonize the at least one damage, namely in and/or at and/or on the at least one electrode, in particular the material, preferably the electrochemically active material of the at least one electrode.

In the sense of the present invention the requirement that the at least one protective device is “substantially an integral” part or constituent of the at least one cell component, preferably of the electrode, means that the protective device cannot be separated without physical and/or chemical separation procedures, in particular cannot be completely separated, respectively optionally cannot be separated at all or only in small amounts.

In one embodiment the at least one protective device is distributed substantially homogeneously in the electrode slurry, comprising at least electrochemically active material and at least one solvent, preferably selected from N-methylpyrrolidone (NMP), preferably binder, and thus becomes an substantially integral part of the at least one electrode.

In one embodiment, the at least one protective device is applied to the electrodes, preferably brushed, sprayed, poured, or disposed and thus becomes substantially an integral part of the electrodes.

The at least one protective device can also be and preferably additionally be a part of the at least one electrolyte and/or the separator.

In one embodiment, the at least one protective device is substantially homogeneously distributed in at least one solvent, in particular an organic solvent and/or in at least one polymer and thus becomes part of the at least one electrolyte and/or of the separator.

In one embodiment, the at least one protective device is applied, preferably brushed, sprayed, poured or disposed on the separator or the electrolyte, whereby the electrolyte is preferably designed as polymer electrolyte, and thus becomes part of the separator and electrolyte, which is thereby preferably designed as polymer electrolyte.

In one embodiment, the at least one protective device, which is substantially an integral part of the at least one electrode, can be present in a first design, for example comprising a first stabilizing additive and the at least one protective device, which is part of the at least one electrolyte and/or the separator, is present in a second design, for example comprising a second stabilizing additive.

However, it is also in the sense of the present invention, that the at least one protective device, which is substantially an integral part of the at least one electrode, is substantially identical with the at least one protective device, which is part of the at least one electrolyte and/or the separator, for example comprising a first stabilizing additive.

In a preferred embodiment, the protective device comprises at least one enclosure and at least one protective device, or consists thereof, wherein the enclosure preferably encloses a void (Hohlraum), in which the at least one stabilizing additive is present.

In one preferred embodiment, the at least one protective device, which is substantially an integral part of one cell component, preferably of at least one electrode, comprises in a first design a first stabilizing additive and a first enclosure, and the at least one protective device, which is part of the electrolyte, is present in a second design, comprising a second stabilizing additive and the first enclosure, and the at least one protective device, which is part of the separator, is present in a third design, comprising, as well, the first stabilizing additive and an enclosure, which is different from the first enclosure. However, further combinations of the aforementioned embodiment are also possible.

Preferably, the protective device in the sense of the present invention has at least one maximum spreading (maximale Ausdehnung) in one direction of one dimension of up to 500 μm, preferably of up to 250 μm, further preferred of up to 100 μm, further preferred of up to 50 μm, further preferred of up to 25 μm, further preferred of up to 10 μm, further preferred of up to 5 μm, further preferred of up to 1 μm, further preferred of up to 500 nm, further preferred of up to 250 nm, further preferred of up to 100 nm.

The protective device comprises at least one enclosure, which is part of the protective device.

The enclosure (Umhullung) in particular serves to enclose a void, substantially completely, in particular completely. The void enclosed by the enclosure is subsequently also called as “the inside of the protective device”.

The void can preferably comprise at least one chemical compound. This at least one compound can be present in the void gaseous, liquid or solid. However, it is also possible that two or more compounds or at least one compound mixture is present in the void. Thus, it is, for example, possible that a first gaseous compound and a second solid compound is present in the void. The void can particularly comprise at least one compound, which is designed as stabilizing additive, for example, the voids can be essentially completely filled with at least one stabilizing additive and/or at least one further compound.

Thus, the enclosure represents a barrier between the void, thus the inside of the protective device, and the area surrounding the protective device, which, for example, can comprise electrode material. Thus, the enclosure comprises an inner plane, which is a plane turned towards the void, this is turned to the inside of the protective device, as well as a plane, opposite to the inner plane, thus, an outer plane, thus, a plane which is turned towards the outer area, surrounding the protective area.

If a first tangent is set at a point of the outer area, an another tangent, which is substantially parallel to the first tangent, is set at a point of the inner plane opposite to the point of the outer plane, the perpendicular, thus the straight line, which essentially meets both tangents perpendicular, and connects these with each other, is the distance between the inner plane and the outer plane. This distance is also in particular called the “thickness” of the enclosure.

The mean or the maximum or the minimum distance can be in a preferred embodiment up to 10 μm, preferably up to 5 μm, further preferred up to 2 μm, further preferred up to 1 μm, further preferred up to 0.5 μm, further preferred up to 0.25 μm, further preferred up to 0.1 μm.

In a further embodiment it is also possible that a first enclosure is enclosed of at least a second enclosure; thus, the first enclosure is present within a void, enclosed by the at least second enclosure at least partly or substantially completely, and the first enclosure itself encloses a void at least partly or substantially completely as well.

The at least one enclosure comprises at least one material or consists thereof. The enclosure can also comprise a material mixture of at least two or more materials or consists thereof.

Under “material” in the sense of the present invention it has to be particularly understood at least one compound or at least one compound mixture. The material can be, for example, carbon containing or polymeric.

Furthermore, it is possible that the material of the enclosure is at least partly or substantially identical to the at least one compound which is present in the void enclosed by the enclosure. In particular, if the material of the enclosure and the at least one compound present in the void are essentially identical, it is possible that there is only the outer plane of the enclosure present.

A first compound is identical to a second compound, if the quantitative and qualitative and material, respectively, chemical composition of both compounds are in accordance with each other. If two or more compounds are identical, they have the identical physical, for the compound characteristic properties like, for example, the same melting point, boiling point, or sublimation point. That means, that in case of polymeric compounds, for example also the polymerization degree has to be substantially identical, such that the polymeric compounds can be regarded as identical, since otherwise, for example the melting ranges would differ from each other, and the polymeric compounds would be regarded as compounds which are different from each other.

In one embodiment of the invention it is also possible, that the material of the enclosure is different from the at least one compound, which is present in the void enclosed by the enclosure.

Substantially different is a first compound from a second compound then, if both compounds are not identical.

Preferably, the material is selected such that the enclosure is not damaged during the normal operation of the electrochemical cell, in particular within the determined specific operation parameters.

The enclosure preferably can comprise an organic polymeric material, in particular selected from at least one thermoplastic polymer, in particular at least a polyalkylene-, and/or at least one polyolefin-based polymer, in particular polyethylene and/or polypropylene; polyethyleneterephthalate (PET), polyetherimide, polyamides, polyacrylnitriles, polycarbonates, polysulfones, polyacetates, in particular polyvinylacetate, ethyl-vinylacetate; polyethersulfones, polyvinylidene fluorides, polyvinylidene chlorides, polystyroles, polymethylmethacrylates, polyacetates, polyester, silicones, epoxides or mixtures thereof and/or an inorganic, polymeric material, in particular selected from silicates, zeolithes, borates, phosphates.

The selection of the material respectively of the material mixture of the at least one enclosure should be made in particular depending on the damaging influence which should be antagonized.

If, for example, the damaging influence is heat influence or heat development, it is advantageous to select a material respectively a material mixture for the enclosure, which has a melting point or a melting range at a temperature, for example at 100° C. or higher, but which is preferably above the operation temperature of the electrochemical cell under normal conditions. Thus, if, for example, the electrochemical cell is exposed to a temperature of 100° C. or higher, the enclosure of the protective device melts, thereby releasing the content of the void enclosed by the enclosure.

In a preferred embodiment, the at least one protective device comprises or the at least one enclosure of the at least one protective device comprises a thermoplastic polymer or essentially consists thereof.

This has the advantage that, under heat influence or heat development, the thermoplastic polymer, for example the polyolefin, further preferred the polyethylene and/or polypropylene melts, and distributes itself over the material present in the proximity of the protective device, in particular over the electrochemically active material present in the proximity of the protective device, whereby the incorporation and/or release of lithium ions is reduced, preferably minimized, preferably substantially prevented. This principle is known for an electrochemical cell as a whole from separators, for example SEPARION of the firm Evonik, wherein the pores for the passage of the lithium ions start to melt down, if a so-called “melt-down”-temperature is reached. Thus, the lithium ion diffusion between cathode and anode is interrupted, and the thread of a so-called “thermal runaway” of the cell is minimized. Preferably, such a protective device is disposed on the surface of the electrode plates, which are turned towards the separator or the polymer electrolyte. In contrast to the “melt down”-mechanism known from the separator, which “shuts down” the whole electrochemical cell, the protective device according to the invention has the advantage, that as it is essentially an integral part of a cell component, in particular of an electrode, functions directly and “locally”, thus, only parts of the cell are affected, and not the whole cell is “shut down”.

Furthermore, the enclosure can comprise carbon containing material, in particular selected from crystalline or amorphous carbon, in particular graphite, coal, carbon black, graphene or mixtures thereof.

In a preferred embodiment, the enclosure comprises polymeric material, which is coated with carbon containing material, in particular selected from crystalline or amorphous carbon, in particular graphite, carbon black, graphene or mixtures thereof. Particularly preferred, the outer plane of the enclosure comprises the carbon containing material.

This has the advantage, that the protective device can function as conductive additive in the electrodes as well.

The protective device can comprise at least one stabilizing additive.

The stabilizing additive can preferably be a chemically stabilizing additive.

Under a “stabilizing additive” in the sense of the present invention at least one compound, in particular a chemical compound, respectively a chemical compound mixture, is to be understood, which is particularly designed such that it can at least partly antagonize or prevent at least one damage of the electrochemical cell, in particular of the cell components. Preferably, the stabilizing additive is designed as chemical stabilizing additive, thus, as additive which contributes to the at least partly stabilization of the electrochemical cell by chemical measures. The stabilization of the electrochemical cell can particularly be achieved by at least partly antagonizing or preventing a damage of the electrochemical cell, in particular of at least one cell component, particular at least one electrode and/or electrolyte.

The at least one stabilizing additive is preferably selected from carbonate based compounds, in particular phenylene carbonate, vinylene carbonate, vinylideneethylene carbonate, fluoroethylene carbonate; succinic acid anhydride, lactid, caprolactam, ethylenesulfite, propansulfone, propenesulfone, vinylsulfone; fluorine-containing or non-fluorine-containing lithiumorganoborates, for example lithium-difluoro(oxalato)borate (LiDFOB) or lithium-bis(oxalato)borate (LiBOB) and fluorine-containing or non-fluorine-containing lithiumorganophosphates, for example lithium-tetrafluoro(oxalato)phosphate (LiTFOP) or lithium-tris(oxalato)phosphate(LiTOP), or mixtures thereof. These chemical compounds can react during charging and/or discharging processes with the electrolyte and form at least partly an SEI layer on the surface of at least one electrode, in particular on the surface of the electrochemically active material of the electrode, in particular on the carbon containing negative electrode.

A SEI layer is particularly formed during the initial charging and discharging cycles at least partly on the surface of the electrochemically active material, in particular the electrochemically active material of the negative electrode, which i preferably comprises substantially a carbon containing electrochemically active material.

The formation of the SEI layer can occur due to the reaction of a lithium ion containing electrolyte with the surface of the active material. Furthermore, it is also possible that the formation of the SEI layer is due to the reaction of an additive, influencing the SEI layer formation, like, for example, LiBOB.

Preferably, on up to 40%, preferably on up to 70%, further preferred on up to 100% of the surface of the electrochemical active material a SEI layer is formed.

Preferably, the SEI layer has an average thickness of greater than 0 nm up to 20 nm, preferably up to 30 nm, preferably up to 40 nm, preferably up to 50 nm, further preferred up to 60 nm. In a preferred embodiment, the SEI layer has an average thickness of 30 nm and more and 50 nm and less.

Preferably, the SEI layer comprises electrical isolating and lithium ion conducting properties.

Preferably, the SEI layer comprises at least partly compounds of the following group: inorganic lithium salts, in particular LiF, LiOH, Li₂O, (semi)carbonates, in particular Li₂CO₃, ROCO₂Li (wherein R=alkyl-, olefin-, alkenyl-, or aromatic substituents) and (CH₂OCO₂Li)₂, polymeric compounds, like, for example, polyolefines, or mixtures thereof.

A SEI layer contributes to the safety of the electrochemical cell by preventing at least partly, preferably completely a lithium dendrite growth. Furthermore, the SEI layer protects, in particular, the electrochemically active material against undesired reactions with the electrolyte and thus contributes to antagonize the decomposition of the electrochemical active material and the therewith related capacity loss of the electrochemical cell.

The stabilizing additive is further preferably selected from elemental sulfur, in particular S₈, polysulfides, in particular Li₂S₈, inorganic or organic or polymeric, sulfur containing compounds, in particular trifluoromethanesulfonate salts.

These chemical compounds can contribute to degradate lithium dendrites. This, in particular, occurs due to the reaction of elemental lithium, out of which the lithium dendrites are composed, with the sulfur, which is contained in the mentioned chemical compounds, under formation of lithiumpolysulfides and/or lithium sulfide, in particular Li₂S. The use of such a stabilizing additive is, in particular, then advantageous, if an electrochemically active material is chosen, which tends to lithium dendrite formation, like, for example, metallic lithium, which is used as electrochemically active material in negative electrodes, like, for example, described in in GB 2459577.

The stabilizing additive can be further selected from at least one tertiary amine, in particular from triethyl amine, tributyl amine, tripropyl amine, tribenzyl amine, trioctyl amine, triphenyl amine or methylpiperidine.

This is particularly advantageous if an non-aqueous electrolyte comprising an organic solvent is present in the electrochemical cell, which tends to polymerization at higher temperatures, in particular at temperatures above 100° C. and/or higher voltages, in particular voltages above 4 V, whereby the inner resistance and thus the temperature within the cell increases. The stabilizing additive can then particularly act as polymerization inhibitor. This is, for example, the case if solvents based on dioxolane are used, for example as described in DE 4406617.

The stabilizing additive can be further selected from at least one nitrogen containing polymer, in particular a highly branched nitrogen containing polymer, in particular having a mean molecular weight (Zahlenmittel) of 1,500 and more, in particular of 200 to 3,000, which can be derived from reaction of amines, ni particular primary, secondary or tertiary amines, like, for example, 1,1′-bis(methoxylcarbonyl)-divinyl-amine, N-methyl-N,N-divinylamine or divinylphenylamine; amides, in particular primary or secondary amides, like, for example, N-vinylamide, divinylamide, silyl(vinyl)-amide or glyoxylated vinylamide; imides, in particular divinylimides, like, for example, N-vinylimide, N-vinylphthalimide or vinylacetamide; maleimides, in particular monomaleimides, bismaleimides, trismaleimides or polymaleimides, like, for example, NN-bismaleimide-4,4′-diphenylmethane, 1,1′-(methylenedi-4,1-phenylene)-bis-maleimide, N,N′(1,1′-biphenyl-4,4′-diyl)-bismaleimide, N,N′-(4-methyl-1,3-phenylene)-bismaleimide, 1,1′-(3,3′-dimethyl-1,1′-biphenyl-4,4′-diyl)-bis-maleimide, N,N′-ethylenedimaleimide, N,N′(1,2-phenylene)-dimaleimide, N,N′-(1,3-phenylene)-dimaleimide, N,N′-thiodimaleimide, N,N′-dithiomaleimide, N,N′-ketonedimaleimide, N,N′-methylene-bis-maleinimide, bis-maleinimidomethyl-ether, 2-bis-(maleimido)-1,2-ethandiol, N,N′-4,4′-diphenylether-bis-maleimide or 4,4′-bis-(maleimido)-diphenylsulfone; or imines, like, for example. divinylimine or allylimine; with diones, in particular barbituric acid or derviatives of barbituric acid or acetylacetone or derivatives of acetylacetone.

This selection of a stabilizing additive has the advantage, that this additive can take part in redox reactions with the electrochemically active material of the anode or cathode, and thus can form a nanoporous protective film, preferably designed as SEI layer, on the surface of the electrochemically active material, which is stable. At elevated temperatures, in particular at temperatures of 80° C. to 280° C., the polymer undergoes a crosslinking reaction, which results in that the ion diffusion through the protective layer is reduced, in particular prevented, this, in turn, contributes that a thermal runaway of the cell is prevented, which further contributes to the safety of the electrochemical cell. Furthermore, this protective layer can particularly protect the electrochemical active material of the positive electrode, such that the diffusion of oxygen out of the electrochemically active material is reduced, particularly prevented, which can occur, if the electrochemical cell is exposed to elevated temperatures. This is, for example, described in US 2010/0167129.

Furthermore, the stabilizing additive can be selected from a compound comprising at least one Si—O—Si bond and/or at least one C—C double bond, in particular comprising at least one siloxane unit framework and at least one functional group comprising a C—C double bond, wherein the compound has a molecular weight of preferably 120 to 250 mg/mol.

This selection of a stabilizing additive has the advantage that such a protection layer, particularly designed as 5E1 layer on at least one electrode, in particular on the electrochemically active material of the at least one electrode, in particular of the negative electrode, is at least partly formed such that the electrochemically active material is protected against undesired reactions. Furthermore, impurities, which are contained in the positive electrode, in particular in the electrochemical active material of the positive electrode, or which are formed during operation of the electrochemical cell and which diffuse into the electrolyte and thus damage the electrolyte or the negative electrode, can be inactivated. This is, for example, described in EP 2357692.

Furthermore, the stabilizing additive can be selected from at least one bismuth containing compound, in particular bismuth containing oxides, bismuth containing nitrides, bismuth containing sulfides, bismuth containing fluorides, bismuth containing amines, bismuth containing acetates, like, for example, Bi₂O₃, BiOF, BiF₃, BiF₅, NH₄BiF₄, NH₄BiF₆, NH₄Bi₃F₁₀, Bi(C₂H₃O₂)₃; or mixtures thereof, wherein the at least one bismuth containing compound is present as solid, in particular in particle form having an average size of 3 to 900 nm, preferably 3 to 500 nm, further preferred 5 to 300 nm.

This selection of a stabilizing additive has the advantage that thus a protective layer on the surface of the at least one electrode, in particular on the surface of the electrochemically active material, preferably on the positive electrode is at least partly formed, whereby the electrode, in particular the electrochemically active material of the electrode, is protected against the influence of acids, which can be formed, for example, during charging and discharging cycles, in particular at high temperatures or if humidity, in particular water, gets into the electrochemical cell and be formed in the electrolyte. Furthermore, this protective layer can also contribute to at least partly prevent a reaction of the electrolyte during charging and discharging processes, in particular at higher temperatures, with the electrochemically active material and/or can contribute to prevent structural changes of the electrochemical active material and/or can at least partly prevent that compounds, in particular transition metal compounds, diffuse out of the electrochemically active material into the electrolyte. All this contributes to the improvement of the safety as well as to the long life of the electrochemical cell and is exemplarily described in US 2010/0151331.

The aforementioned embodiment of the at least one stabilizing additive is advantageously released from the enclosure of the protective device in order to develop the described effects and thus antagonizing or preferably preventing the damage.

Thus, it is advantageous, if the at least one stabilizing additive is present in a form already at this time, when the additive is still enclosed by the enclosure and thus not released, in which it can act immediately if needed.

Thus, in case of LiBOB, for example, it is advantageous, if it is already present in dissolved form in the enclosure, for example dissolved in a solvent, which is as well present in the electrolyte of the electrochemical cell. In case of compounds, which are insoluble or do not act in dissolved form, it is, for example, advantageous to put them into a polymer matrix, wherein the at least one polymer which is comprised in the polymer matrix, can form the enclosure at the same time and, for example by melting or by dissolving, for example, in the presence of water, can release the at least one composition.

This has the further advantage, that thus the at least one stabilizing additive can be released selectively, for example then, if a determined temperature is reached, at which the at least one polymer of the polymer matrix begins to melt; or if a damaging compound, like, for example, water or acid is present, with which the at least one polymer of the polymer matrix can react and is thus degraded or dissolved in the damaging compound.

The latter is, for example, the case if the polymer matrix is built of a cellulose based polymer, since this one can be dissolved in water. In a case, if the at least one polymer of the polymer matrix starts to melt at a defined temperature, wherein the temperature at which the polymer starts to melt is preferably depending on the crosslinking degree of the polymer, said at least one polymer can also comprise a binder function at the same time, and thus contributing to the adhesion of the stabilizing additive, for example, on the surface of the electrochemically active material, like it is, for example, the case if the stabilizing additive is designed as bismuth containing compound.

As already mentioned, the melting temperature, respectively temperature range, of a polymeric compound, in particular of thermoplastic polymers, can depend on the polymerization degree. A low polymerization degree leads to a lower melting temperature, respectively temperature range, while, for example, a higher polymerization degree leads to a higher melting temperature, respectively temperature range. Thus, it can be controlled starting at which temperature, respectively at which temperature range, the stabilizing additive is released, in an easy way.

However, it is also in the sense of the present invention, that the at least one stabilizing additive is not released from the enclosure.

This is, in particular, then advantageous, if the at least one stabilizing additive is designed as adsorption medium (Aufnahmemedium) and absorbs and thus binds, for example, damaging compounds from the proximity, which are formed if a damaging influence occurs, thus that the damaging compounds are not released into the proximity any more, However, it is also possible, that the damaging compound is absorbed from the proximity and transformed into a non-damaging compound which then is allowed to get into the proximity again. Thus, a damaging of the electrochemical cell, in particular of the cell components, in particular of at least one electrode and/or the electrolyte by a damaging compound can be antagonized, preferably prevented. In a preferred design of said embodiment the enclosure is coated with carbon containing material, such that the at least one protective device, preferably present within the electrodes, can additionally act as conducting additive.

The at least one stabilizing additive can thereby be selected from:

at least one compound which can antagonize a damage by water, in particular earth alkali metal oxides, like, for example, magnesium oxide or calcium oxide, boric oxides or zeolithes,; and/or
at least one compound which can antagonize a damage by CO₂, in particular carbon molecular sieves (CMS), alkali- and earthalkalimetalhydroxides, like, for example, lithium and sodium hydroxide, lithium salts LiXO_{y}, with X=zircon, iron, nickel, titanium, silicon and Y=2-4, MOFs (=metal organic framework), which are particularly functionalized with basic functional groups, like, for example, amine groups; and/or
at least one compound which can antagonize a damage by CO, in particular cobalt(II, Ill) oxides, like, for example, Co₃O₄, copper(II) oxides, like, for example, CuO, potassium permanganate, wherein optionally additionally an oxidation catalyst, for example on basis of platinum, palladium or rhodium; and/or
at least one compound which can antagonize a damage by hydrogen, in particular palladium oxide, cobalt oxide, ternary alloys from the elements zirconium, vanadium and iron or zirconium, cobalt and rare earths, unsaturated organic compounds; and/or
at least one compound which can antagonize a damage by saturated or unsaturated carbon hydrogen compound(s), in particular methane, propylene, ethane and propane, activated carbon having a high surface, carbon nanotubes, oxidizing compounds, like potassium permanganate; and/or
at least one compound which can antagonize a damage by oxygen, in particular ternary alloys, like, for example, from the elements zirconium, vanadium and iron or zirconium, cobalt and rare earths, metals, like nickel, copper, iron, reducing or partly reducing metal oxides, for example comprising iron, nickel, tin, copper; and/or
at least one compound which can antagonize a damage by HF, in particular oxides, like, for example, alkali or earthalkali metal oxides, in particular magnesium oxide.

The at least one stabilizing additive can thereby be embedded into a polymer matrix, comprising at least one polymer, in particular selected from ethylvinyl acetate or polyesters, like, for example, polycarbonate.

This is advantageous, since in particular ethylvinyl acetate or polyesters comprise a permeability for compounds, in particular for damaging compounds like, for example, water, CO₂ or HF.

Furthermore, it is advantageous that the at least one stabilizing additive, which is embedded in one polymer matrix in one embodiment, is enclosed by at least one enclosure, which is, in particular, selected from polyolefines, preferably polyethylene, in particular LDPE (=low density polyethylene), polypropylene, polystyrol, thermoplastic olefines (TPE) or fluorinated polymers like polytetrafluoroethylene. This is, for example, described in US 2010/0183914.

Furthermore, it is possible that the at least one stabilizing additive is selected from at least one phase change material (PCM=phase change materials), which is particularly advantageous, since PCMs are capable of absorbing thermal energy from the proximity, in particular in order to store the energy or to emit energy into the proximity. The adsorption, in particular the storage, respectively the emitting of thermal energy occurs by phase transition of the material, for example from solid to liquid or vice versa. Thus, it can be contributed to regulate the temperature within the electrochemical cell, in particular to lower the temperature, or, in these cases if the electrochemical cell is exposed to low, which means cold temperatures, to increase the temperatures. In particular, of heat develops within the electrochemical cell, in particular within the cell components, in particular within at least one electrode, which, for example, develops by exothermic undesired chemical reactions or by heat influence from outside the electrochemical cell the temperature within the cell can be regulated.

The temperature, respectively the temperature range, in which the phase transition takes place, is dependent on the phase change material. Preferably, the at least one phase change material is selected such that the phase transition of the at least one phase change material takes place in a temperature range which overlaps with the temperature maximum and/or temperature minimum of the operation temperature range of the electrochemical cell. For example, if an electrochemical cell has an operation temperature range of −10° C. to 40° C., it is particularly advantageous to select a phase change material, which has a phase transition temperature in a temperature range of 20° C. and higher or up to, for example, 60° C., or from 20° C. and lower, for example down to −30° C. However, it is advantageous as well to use a phase change material which comprises a phase transition temperature in a temperature range which overlaps with the operation temperature range of an electrochemical cell. If, for example, an electrochemical cell has an operation temperature range of −10° C. to 40° C., it is advantageous to select a phase change material which has a phase transition in a temperature range of 20° C. (or lower) up to 60° C. (or higher).

Furthermore, it is advantageous to use two or more phase change materials, each having a phase transition temperature in a temperature range which differs from each other. Thus, if, for example, an electrochemical cell has an operation temperature range of −10° C. to 40° C., it is advantageous to choose a phase change material, which comprises a phase transition temperature in a temperature range of 20° C. and higher, for example up to 60° C., and a second phase change material, which comprises a phase transition temperature in a temperature range of 20° C. and lower, for example down to −30° C.

The at least one phase change material can be selected from organic compounds, like, for example, described in U.S. Pat. No. 6,703,127 B, and/or from inorganic compounds, like, for example, described in DE 10 2005 002 169 A and/or inorganic-organic compounds like, for example, described in US 2011/0017944 A.

Furthermore, it is possible that the at least one stabilizing additive is selected from strongly hydrophobic compounds like hydrophobic silicon-oxygen compounds.

In one embodiment, the strongly hydrophobic compound is present as dispersion which contributes positively to an improved distribution of the strongly hydrophobic compound in the proximity of the protective device.

This has the advantage, that the wetting of the surfaces of the cell components, in particular of the separator and/or the electrodes, in particular of the electrochemically active material of the electrolyte, is reduced, preferably minimized, preferably prevented, which contributes to the safety of the electrochemical cell.

Since the liquid electrolyte makes the lithium ion diffusion between anode and cathode of an electrochemical cell possible at all, the lithium ion diffusion is reduced, preferably minimized, preferably prevented if the cell component, in particular the separator and/or the electrodes, in particular the electrochemically active material, is preferably no longer wetted, preferably if the wetting is minimized or prevented. The effect, to prevent the wetting of surfaces, is known from other applications like the bio-mimetic as so-called “lotus effect”.

Furthermore, it is advantageous if the at least one stabilizing additive is selected from a metal or a metal alloy, which is present preferably at temperatures of 60° C. and lower in liquid form. Preferably, the metal is selected from, respectively comprises a metal alloy comprising a metal, which is selected from gallium and/or indium.

This has the advantage that thus the at least one stabilizing additive can be easily distributed into areas where a damage is present. In particular in this case, in which a crack formation within the material of the electrochemical cell, in particular within the electrode and/or a delamination of a first cell component from a second cell component takes place, it is advantageous, that the at least one stabilizing additive is distributed, in particular is “outpoured” (“ergieβen”) into these areas, such that within these areas an electron and/or ion flow is again possible. Furthermore, by filling the cracks and/or the formed empty spaces at the points where the first cell component delaminates from the second cell component, the formation of lithium dendrites or the deposition of spongy (schwammartig) lithium is reduced, preferably minimized, preferably prevented.

In one embodiment, the metal or the metal alloy is essentially completely enclosed by an enclosure comprising a urea resin, substantially ureaformaldehyde resin.

The term “substantially”, “essentially” as previously and subsequently used means at least 50%, at least 75%, at least 90%, at least up to 99%, preferably 100%—each within the respective existing measurement error, respectively the usual purity level in each case of use.

### Electrolyte

In one embodiment, the electrochemical cell comprises at least one electrolyte.

A non-aqueous electrolyte comprising of at least one organic solvent and at least one alkali ion-containing, preferably lithiumion-containing inorganic or organic salt may be used as electrolyte.

Generally solvents can be used which are known by the skilled person and which are used in electrochemical cells can be used as organic solvents.

Preferably, the organic solvent is selected from ethylene carbonate (EC), propylene carbonate (PC), diethyl carbonate (DEC), dipropyl carbonate (DPC), ethylmethyl carbonate (EMC), methylformiate (MF), methyl acrylate (MA), methyl butyrate (MB), ethyl acetate (EA), 1,2-dimethoxyethane, γ-butyrolactone, tetrahydrofuran (THF), 2-methyltetrahydrofuran, 1,3-dioxolane, sulfulane, ethylmethyl sulfone (EMS), tetramethylene sulfone (TMS), butyl sulfone (BS), ethylvinyl sulfone (EVS), 1-fluoro-2-(methyl sulfonyl) benzene (FS), acetonitrile or phosphoric acid ester, or mixtures of these solvents.

Preferably, alkali ion-containing, preferably the lithium ion-containing salt comprises one or more counter-ions selected from AsF6⁻, PF6⁻, PF3(C2F5)3⁻, PF3(CF3)3⁻, BF4⁻, BF2(CF3)2⁻, BF3(CF3)⁻, [B(COOCOO)2⁻, [(C2F5SO2)N]⁻, [(CN)2N]⁻, ClO4⁻, SiF6− or mixtures thereof.

In one embodiment ionic liquids can be used as solvents as well. Such “ionic liquids” contain only ions. Preferred cations which can particularly be alkylated, are imidazolium, pyridinium, pyrrolidinium, guanidinium, uronium, thiuronium, piperidinium, morpholinium, sulfonium, ammonium and phosphonium cations. Examples for anions which can be used are halgenide, tetrafluoroborate, trifluoroacetate, triflat, hexafluorophosphate, phosphinate and tosylate anions.

Exemplarily, following ionic liquids are mentioned: N-methyl-N-propyl-piperidinium-bis(trifluoromethylsulfonyl)imide, N-methyl-N-butyl-pyrrolidinium-bis(trifluoromethyl-sulfonyl)imide, N-butyl-N-trimethyl-ammonium-bis(trifluoromethylsulfonyl)imide, triethylsulfonium-bis(trifluoromethlysulfonyl)imide, N,N-diethyl-N-methyl-N-(2-methoxyethyl)-ammonium-bis(trifluoromethlysulfonyl)-imide.

Preferably, the separator of the electrochemical cell is saturated with the electrolyte.

Furthermore, the electrolyte can comprise additives which typically find application in electrolytes for lithium ion batteries. For example, said additives can be radical scavengers such as biphenyl, fire-retardant additives such as organic phosphoric acid esters or hexamethyl phosphorous amide, or acid scavengers such as amines.

Furthermore, the electrolyte preferably comprise additives, preferably, phenylen carbonate, fluorine containing or non-fluorine containing lithium organoborates, for example lithium difluoro (oxalato) borate (LiDFOB), or lithium bis(oxalato) borate (LiBOB) and fluorine containing or non-fluorine containing lithium organophosphate, for example lithium tetrafluoro (oxalato) phosphate (LiTFOP) or lithium tris (oxalato) phosphate (LiTOP), which may influence the formation of the SEI layer on the electrodes.

In one embodiment, the electrolyte is designed as polymer electrolyte, which comprises in addition to the afore mentioned salts, solvents, aids and additives a polymer matrix. The polymer or the polymer mixture are preferably selected from polymers used in separators.

In one embodiment, a polymer electrolyte of a lithium salt and polyethylene oxide is used.

### Electrodes

Under a “negative electrode” in the sense of the present invention, a device is to be understood, which in particular releases electrons when connecting to a load, such as an electric motor. Thus, the negative electrode is the anode according to this convention.

Preferably, the negative electrode comprises at least one electrochemically active material which is suitable for intercalating and/or releasing redox components, in particular lithium ions.

In one embodiment, the electrochemical active material of the negative electrode is selected from the group comprising amorphous graphite, crystalline graphite, meso carbon, doped carbon, fullerenes, carbon containing materials, lithium metal, lithium metal, lithium metal alloys, titanates, silicates, silicium, silicium alloys, tin, tin alloys, or mixtures thereof.

Preferably, the negative electrode additionally comprises to the electrochemically active material at least one further additive, preferably an additive for increasing conductivity, for example based on carbon, such as carbon black, and/or a redox-active additive which, when overcharging the electrochemical cell, reduces the destruction of the electrochemically active material, preferably minimizes same, preferably prevents same.

Preferably, the negative electrode comprises a metallic substrate. Preferably, this metallic substrate is at least partially coated with electrochemically active material.

In one embodiment, the negative electrode comprises a binder which is suitable for improving the cohesion in the active material and/or the adhesion between electrochemically active material and a metallic substrate. Preferably, such binder comprises a polymer, preferably a fluorinated polymer, preferably polyvinylidene fluoride, which is sold under the trademark Kynar® or Dyneon®, polyethylene oxide, polyethylene, polypropylene, polytetrafluoro ethylene, polyacylate, ethylene (propylene-dien-monomer) copolymer (EPDM) or mixtures or copolymers thereof.

Under “positive electrode” in the sense of the invention, a device is to be understood, which in particular accepts electrons when connecting to a load such as an electric motor. Thus, the positive electrode is the cathode according to this convention.

Preferably, the positive electrode of the electrochemical cell comprises at least one electrochemically active material which is suitable for intercalating and/or releasing redox components, in particular lithium ions.

In one embodiment, the electrochemically active material of the positive electrode is selected from at least one oxide, preferably a mixed oxide which comprises one or more elements selected from nickel, manganese, cobalt, aluminum, phosphorus, iron, or titanium.

In one embodiment, the positive electrode comprises a compound having the formula LiMPO₄, wherein M is a least one transition cation, preferably a transition cation of the first row of the transition metals of the periodic table of the elements.

The at least one transition cation is preferably selected from the group consisting of manganese, iron, nickel, cobalt or titanium, or a combination of these elements. The compound preferably has an olivine structure, preferably super-ordinated olivine, wherein iron or cobalt is particularly preferred, preferably LiFePO₄ or LiCoPO₄. However, the compound can also have a structure which is different from the olivine structure.

In a further embodiment, the positive electrode comprises an oxide, preferably an oxide of a transition metal, or a mixed oxide of a transition metal, preferably in the crystal structure of the spinel type, preferably a lithium manganate, preferably LiMn₂O₄, a lithium cobaltate, preferably LiCoO₂, or a lithium nickelate, preferably LiNiO₂, or a mixture of two or three of these oxides. However, the oxides can also comprise a structure which is different from the spinel type.

Further preferred, in addition to the afore mentioned transition metal oxides, the positive electrode may comprise a lithium transition metal mixed oxide or exclusively comprise a lithium transition metal mixed oxide comprising manganese, cobalt and nickel, preferably a lithium cobalt manganate, preferably LiCoMnO₄, preferably a lithium nickel manganate, preferably LiNi_{0.5}Mn_{1.5}O₄, preferably a lithium nickel manganese cobalt oxide, preferably LiNi_{0.33}Mn_{0.33}Co_{0.33}O₂, or a lithium nickel cobalt oxide, preferably LiNiCoO₂, which may be preferably not of spinel type or be present in spinel type.

In one embodiment, the positive electrode comprises sulfur or a sulfide, in particular a metal sulfide or a metal polysulfide, preferably a metal selected from the transition metals, which can form a sulfide or polysulfide together with sulfur, in particular iron or selected from the main group metals, which can form a sulfide or polysulfide together with sulfur, in particular lithium.

Preferably, additionally to the electrochemically active material, the positive electrode comprises at least one further additive, preferably an additive for increasing conductivity, for example based on carbon, for example carbon black, and/or a redox-active additive which, when overloading the electrochemical cell, reduces the destruction of the electrochemically active material, preferably minimizes same, preferably prevents same.

Preferably, the positive electrode comprises a binder which is suitable for improving the adhesion between electrochemically active material and a metallic substrate. Preferably, such binder comprises a polymer, preferably a fluorinated polymer, preferably polyvinylidene fluoride, which is sold under the tradenames Kynar® or Dyneon® polyethylene oxide, polyethylene, polypropylene, polytetrafluoro ethylene, polyacylate, ethylene (propylene-dien-monomer) copolymer (EPDM) or mixtures or copolymers thereof.

Preferably, the positive electrode comprises a metallic substrate. Preferably, said metallic substrate is at least partially coated with an electrochemically active material.

The term “metallic substrate” in the sense of the present invention preferably relates to such component of an electrochemical cell which is known as “electrode carrier” and “collector”. The metallic substrate as used herein is suitable for applying electrochemically active mass and is substantially of metallic nature, preferably completely metallic nature.

Preferably, at least one electrode comprises at least partially a metallic substrate. Preferably, said metallic substrate is at least partially developed as foil or as net structure or as fabric, preferably comprising a metal.

In one embodiment, a metallic substrate comprises copper or a copper-containing alloy. In a further embodiment, a metallic substrate comprises aluminum. In one embodiment, the metallic substrate can be developed as foil, net structure or fabric, which preferably at least partially comprises at least one plastics.

Preferably, up to 30%, preferably up to 50%, preferably up to 70%, preferably up to 100% of the total surface of a metallic substrate comprises at least one layer which comprises at least one electrochemically active material which is suitable for intercalating and/or removing lithium ions.

### Separator

In one embodiment, a separator is used which separates the positive electrode from the negative electrode, and which is not or only poorly conductive for electrons, and which consists of at least one at least partially material-permeable carrier. The carrier preferably is coated on one side with an inorganic material. As at least partially material-permeable carrier, preferably an organic material is used which, preferably, is developed as non-woven fabric.

The organic material which is preferably a polymer and, in particular preferred, one or more polymers selected from polyethylene terephthalate (PET), polyolefin or polyether imide, is coated with an inorganic, preferably ion-conducting material, which further preferably is ion-conducting in a temperature range of from −40° C. to 200° C., and preferably comprises at least one compound from the group of the oxides, phosphates, silicates, titanates, sulfates, alumosilicates having at least one of the elements zirconium, aluminum, lithium and, in particular preferred, zirconium oxide.

Preferably, the inorganic, ion-conducting material of the separator comprises particles having a diameter size below 100 μm, preferably below 10 μm, preferably of from 0.5 to 7 μm, preferably of from 1 to 5 μm, preferably of from 1.5 to 3 μm.

In one embodiment, the separator has a porous inorganic coating which is on and in the non-woven fabric, which comprises aluminum oxide particles having an average particle size of from 0.5 to 7 μm, preferably from 1 to 5 μm and further preferably from 1.5 to 3 μm, which are bonded with an oxide of the elements Zr or Si.

In order to achieve porosity as high as possible, preferably more than 50 wt.-% and in particular preferred, more than 80 wt.-% of all particles are within the above-mentioned limits of the average particles size. Preferably, the maximum particle size preferably is ⅓ up to ⅕ and, in particular preferred, less or equal to 1/10 of the thickness of the applied non-woven fabric.

Preferred polyolefins are preferably polyethylene, polypropylene or polymethylpentene. Particularly preferred is polypropylene. The use of polyamides, polyacrylnitriles, polycarbonates, polysulfones, polyethersulfones, polyvinylidene fluorides, polystyrenes as organic carrier material is likewise conceivable. Also mixtures of said polymers may be used.

A separator having PET as carrier material is commercially available under the trademark Separion®. It may be produced according to methods which are disclosed in EP 1 017 476.

The term “non-woven fabric” means that the polymers are present in form of fibers in non-woven form. Such fleeces are known from the prior art and/or may be produced according to known methods, for example by a spinning process or a meltblown manufacturing process as referred to in DE 195 01 271 A1.

Preferably, the separator comprises a fleece having an average thickness of from 5 to 30 μm, preferably of from 10 to 20 μm. Preferably, said fleece is flexibly developed. Preferably, the fleece has a homogeneous distribution of the pore radii; preferably, at least 50% of the pores have a pore radius of from 75 to 100 μm. Preferably, the fleece has a porosity of 50%, preferably of from 50 to 97%.

“Porosity” is defined as volume of the fleece (100%) minus volume of the fibers of the fleece (corresponds to the amount of the volume of the fleece which is not filled by material). Thereby, the volume of the fleece may be calculated from the dimensions of the fleece. The volume of the fibers results from the measured weight of the fleece and the density of the polymer fibers. The high porosity of the fleece also enables a higher porosity of the separator, for which reason a higher incorporation of electrolyte with the separator can be achieved.

In a further embodiment, the separator consists of a polyethylene glycol terephthalate, a polyolefin, a polyetherimide, a polyamide, a polyacrylnitrile, a polycarbonate, a polysulfone, a polyethersulfone, a polyvinylidene fluoride, a polystyrene, or mixtures thereof. Preferably, the separator consists of a polyolefin or of a mixture of polyolefins. Particularly preferred in this embodiment is then a separator which consists of a mixture of polyethylene and polypropylene.

Preferably, such separators have a layer thickness of from 3 to 14 μm.

The polymers are preferably in the form of a fiber fleece, wherein the polymer fibers have an average diameter of from 0.1 to 10 μm, preferably of from 1 to 4 μm.

The term “mixture” or “blend” of polymers in the sense of the present invention means that the polymers preferably are present in form of their fleeces which are connected to each other in a layered form. Such fleeces, respectively fleece composites, are, for example, disclosed in EP 1 852 926.

In a further embodiment of the separator, said separator consists of an inorganic material. Preferably, as inorganic material oxides of magnesium, calcium, aluminum, silicon and titanium are used as well as silicates and zeolites, borates and phosphates. Such materials for separators and methods for the manufacture of separators are disclosed in EP 1 783 852. In a preferred embodiment of this embodiment of a separator, the separator consists of magnesium oxide.

According to a further embodiment, the at least one separator, which is not or only poor electron conducting, but is conducting for ions, consist substantially respectively completely of a ceramic, preferably an oxide ceramic. This embodiment has the advantage, that the durability of the electrode group at temperatures above 100° C. is improved.

In a further embodiment of the separator, 50 to 80 wt.-% of magnesium oxide may be replaced by calcium oxide, barium oxide, barium carbonate, lithium phosphate, sodium phosphate, potassium phosphate, magnesium phosphate, calcium phosphate, barium phosphate or by lithium borate, sodium borate, potassium borate, or mixtures of these compounds.

Preferably, the separators of this embodiment have a layer thickness of from 4 to 25 μm.

Further, the invention relates to a method of manufacturing an electrochemical cell according to the invention, comprising the following steps:
a) providing at least one protective device, comprising at least one enclosure and at least one stabilizing additive,
b) providing at least one cell component or at least one part of the cell component which should be equipped with the at least one protective device,
c) providing at least one further cell component, which should not be equipped with the at least one protective device,
d) equipping the at least one cell component with the at least one protective device, in particular using a method as prior described,
e) assembling of all cell components to an electrochemical cell,
   wherein the steps a), b), c), and d) can be substantially conducted in any order, and wherein step c) is not conducted of all cell components are equipped with at least one protective device, and wherein steps a), b), and d) can be discretionary frequently.

One embodiment of the method of manufacturing an electrochemical cell according to the invention comprises the following steps:
a) providing at least one protective device, comprising an enclosure, which is coated with a carbon containing material and further comprising at least one stabilizing additive,
b1) providing an electrode material, at least comprising electrochemically active material and binder;
c1) mixing the at least one provided protective device from step a) with the provided electrode material from step b1),
d1) providing a metallic substrate,
e1) applying the mixture from step c1) onto the metallic substrate,
f1) finishing of the electrodes from step e1),
g assembling of the finished electrode from the previous step with the further cell components, in particular the counter electrode, the separator and the electrolyte, to an electrochemical cell,
wherein instead of the steps b1)-f1) also the following steps can be conducted:
b2) providing an electrode,
c2) applying a provided at least one protective device of step a) onto the provided electrode of step b2).

Preferably, the electrochemical cell according to the invention comprises a nominal load capacity (Nennladekapazitat) of at least 3 Ampere hours [Ah], further preferred of at least 5 Ah, further preferred of at least 10 Ah, further preferred of at least 20 Ah, further preferred of at least 50 Ah, further preferred of at least 100 Ah, further preferred of at least 200 Ah, further preferred of maximum 500 Ah. This design has the advantage to have an improved operation duration of the consumer which is powered by the electrochemical cell.

Preferably, the electrochemical cell according to the invention comprises a nominal current (Nennstrom) of at least 50 A, further preferred of at least 100 A, further preferred of at least 200 A, further preferred of at least 500 A, further preferred of maximum 1,000 A. This design has the advantage of an improved performance of the consumer powered by the electrochemical cell.

Preferably, the electrochemical cell comprises a nominal voltage (Nennspannung) of at least 1.2 V, further preferred of at least 1.5 further preferred of at least, further preferred of at least 2 V, further preferred of at least 2.5 V, further preferred of at least 3 V, further preferred of at least 3.5 V, further preferred of at least 4 V, further preferred of at least 4.5 V, further preferred of at least 5 V, further preferred of at least 5.5 V, further preferred of at least 6 V, further preferred of at least 6.5 V, further preferred of at least 7 V, further preferred of maximum 7.5 V. Preferably, the secondary cell comprises lithium ions. This design has the advantage of an improved energy density of the electrochemical cell.

Preferably, the electrochemical cell according to the invention comprises an operation temperature range between −40° C. and 100° C., further preferred between −20° C. and 80° C., further preferred between −10° C. and 60° C., further preferred between 0° C. and 40° C. This design has the advantage of an preferably unlimited location, respectively use of the electrochemical cell according to the invention for powering a consumer, in particular a car or a stationary complex, respectively machine.

Preferably, the electrochemical cell comprises a gravimetric energy density of at least 50 Wh/kg, further preferred of at least 100 Wh/kg, further preferred of at least 200 Wh/kg, further preferred of at less than 500 Wh/kg. Preferably, the electrode group comprises lithium ions. This design has the advantage of an improved energy density of the electrochemical cell.

According to an preferred embodiment, the electrochemical cell is designed to be placed into a car having at least one electric motor. Preferably, the electrochemical cell is designed to power this electric motor. Particularly preferred, the electrochemical cell is designed to power/supply at least from time to time an electric motor of an power train (Antriebsstrang) of a hybrid or electric car. This design has the advantage of an improved supply of the electric motor.

According to a further preferred embodiment, the electrochemical cell is designed for use in a stationary energy storage device, in particular of a stationary battery, in particular a buffer storage (Pufferspeicher), as device battery, industry battery or starter battery. Preferably, the nominal capacity of the electrochemical cell for these applications is at least 3 Ah, particularly preferred at least 10 Ah. This design has the advantage of an improved supply of a stationary consumer, in particular of a stationary mounted electric motor.

Further advantages, features and applications of the present invention can be derived from the subsequent following description together with the figures.

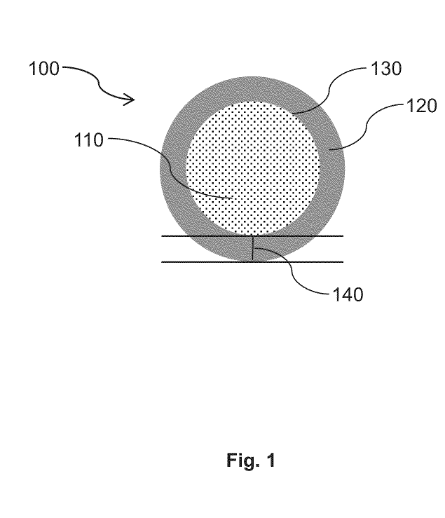

FIG. 1 shows a schematic cross-section of an embodiment of a protective device for use in an electrochemical cell according to the invention.

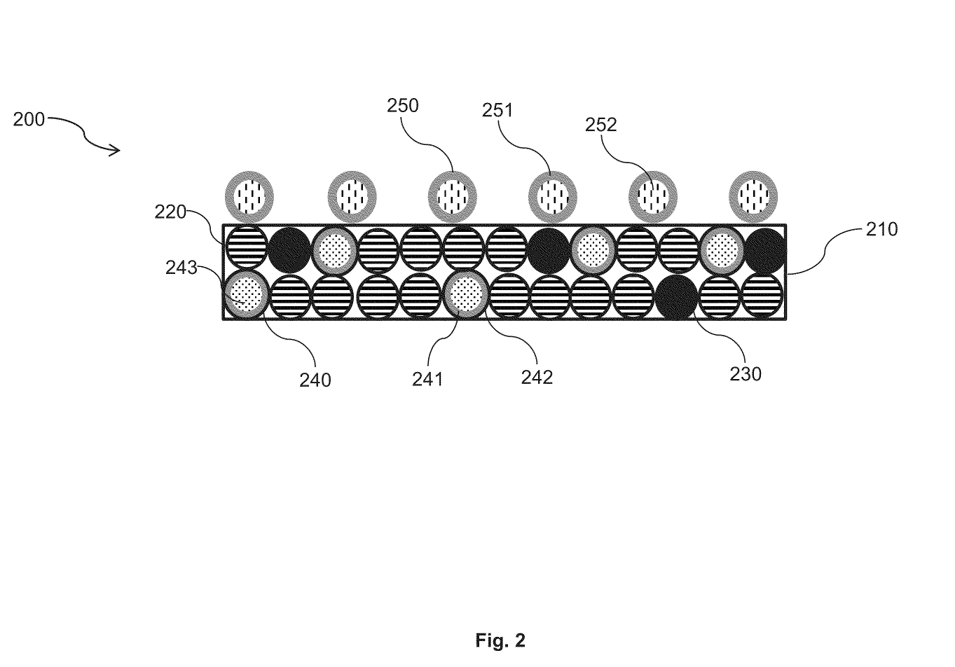

FIG. 2 shows a schematic cross-section of an embodiment of an electrode for use in an electrochemical cell according to the invention.

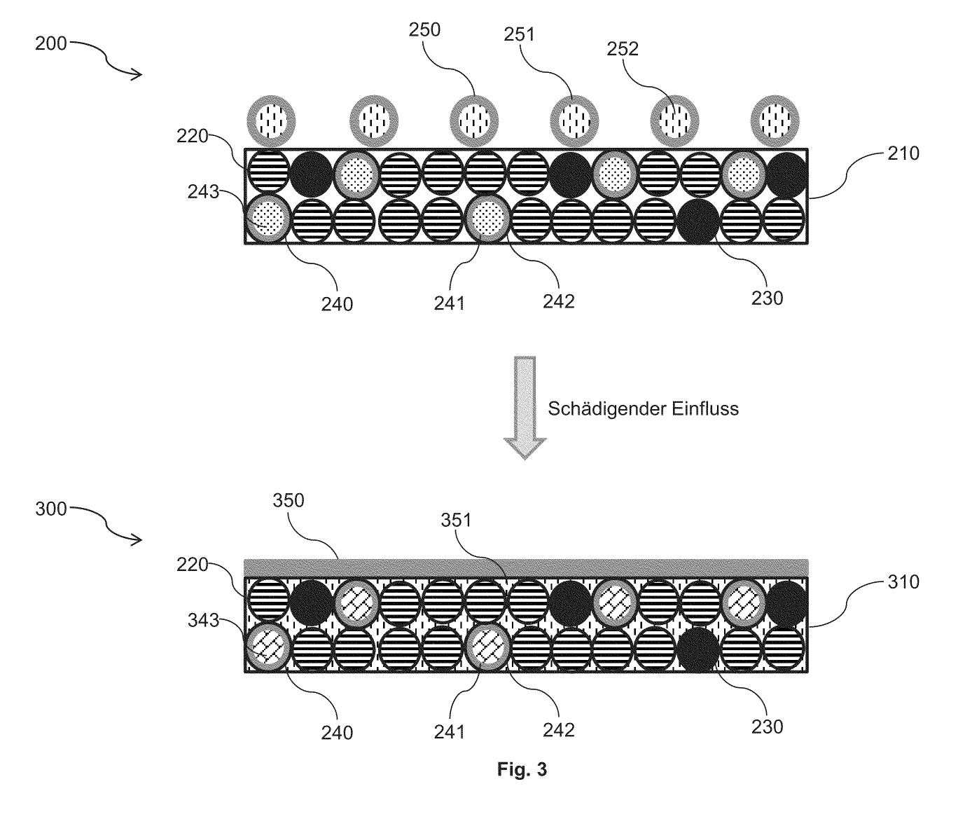

FIG. 3: shows schematically an embodiment of an electrode for use in an electrochemical cell according to the invention at a time prior to the occurrence of a damaging influence and at a time after the occurrence of a damaging influence.

FIG. 1 shows a schematic cross-section of an embodiment of a protective device 100 which is presently designed as microcapsule, for use in an electrochemical cell according to the invention. The protective device 100 thereby comprises an enclosure 120 having a defined thickness 140 and completely enclosing a void 130. The void is essentially completely filled with at least one compound, in particular with at least one stabilizing additive 110.

FIG. 2 shows a schematic cross-section of an embodiment of an electrode 200 consisting of an electrochemically active layer 210, which comprises an electrochemically active material 220, conductive additive 230 as well as a protective device 240, for use in an electrochemical cell according to the invention. The electrochemically active layer 210 is further coated with a second protective device 250, which is different from the first protective device 240. Both protective devices 240, 250 are present as a plurality of microcapsules in the electrode 200. The first protective device 240 consists of an enclosure 241, which is coated with carbon containing material 242. The enclosure 241 encloses a first stabilizing additive 243. The second protective device 250 consists of an enclosure 251, which encloses a second stabilizing additive.

FIG. 3 shows schematically an embodiment of an electrode for use in an electrochemical cell according to the invention, at a time prior to the occurrence of a damaging influence 200 and at a time after the occurrence of a damaging influence 300. The electrode 200 at the time prior to the occurrence of the damaging influence corresponds to the electrode described in FIG. 2. The electrode after occurrence of the damaging influence comprises an electrochemically active layer 310, which is coated with a layer comprising enclosure material 250 of the second protective device 250. The electrochemically active layer 310 consists after the occurrence of the damaging influence of an electrochemically active material 220, which is still essentially identical with the electrochemically active material 220 prior to occurrence of the damaging influence due to the protection effect of the first protective device 240, 340 and the second protective device 250. Furthermore, the electrochemically active layer comprises conductive additive 230 as well as the first protective device 340. The first protective device 340 consists of an enclosure 242, which is coated with carbon containing material 242. The enclosure 242 of the first protective device 340 encloses a first stabilizing additive 351, which is transformed by the occurrence of the damaging influence from a first form 251 into a second form 351 and is presently designed as adsorption medium. Furthermore, the electrochemically active layer 310 comprises after the occurrence of the damaging influence the stabilizing additive 351, which is released from the second protective device 250 after occurrence of the damaging influence and impacts protectively on the electrochemically active material 220.

1-8. (canceled)

9. An electrochemical cell configured to provide at least occasionally electrical energy, comprising:
at least one negative electrode including at least one material which is capable of absorbing charge carrier in the form of lithium ions during charge processes;
at least one positive electrode including at least one material which is capable of releasing charge carrier in the form of lithium ions during charge processes; and
at least one electrolyte, which is capable of transporting charge carrier, in the form of lithium ions, between the at least one negative electrode and the at least one positive electrode; and
at least one protective device, wherein the protective device is an integral part in at least one of the at least one negative electrode and the at least one positive electrode and comprises at least one enclosure,
wherein the at least one protective device is configured such that if a damaging influence in the form of heat damaging the electrochemical cell occurs, at least one stabilizing additive is released from inside the at least one enclosure.

10. The electrochemical cell according to claim 9, wherein the at least one protective device comprises at least one storage container.

11. The electrochemical cell according to claim 10, wherein the at least one storage container is a microcapsule.

12. The electrochemical cell according to claim 9, wherein the at least one stabilizing additive is a chemical stabilizing additive.

13. The electrochemical cell according to claim 9, wherein the stabilizing additive is configured to at least partially mitigate damage to the electrochemical cell caused by the damaging influence.

14. The electrochemical cell according to claim 9, wherein the at least one enclosure of the protective device comprises a carbon-containing material.

15. The electrochemical cell according to claim 14, wherein the carbon-containing material is selected from the group consisting of: crystalline or amorphous carbon, graphite, carbon black, grapheme, and mixtures thereof.

16. The electrochemical cell according to claim 9, wherein the at least one enclosure of the protective device comprises a polymeric material.

17. The electrochemical cell according to claim 16, wherein the polymeric material is selected from the group consisting of: thermoplastic polymers, polyalkylene- or polyolefine-based polymers, and mixtures thereof.

18. The electrochemical cell according to claim 9, wherein the at least one enclosure of the protective device encloses the at least one stabilizing additive, and the stabilizing additive is comprised of material selected from the group consisting of: vinylene carbonate, PCM or polysulfide, and mixtures thereof.

19. The electrochemical cell according to claim 9, wherein the at least one negative electrode is comprised of an electrochemically active material which is selected from the group consisting of: amorphous graphite, crystalline graphite, graphene, carbon-containing materials, lithium metal, lithium metal alloys, titanates, silicates, silicium, silicium alloys, tin, tin alloys, and mixtures thereof.

20. The electrochemical cell according to claim 9, wherein the at least one positive electrode is comprised of an electrochemically active material selected from the group consisting of:
at least one compound LiMPO₄, wherein M is at least one transition metal cation selected from the group consisting of: manganese, iron, cobalt, titanium, and combinations thereof;
at least one lithium metal oxide or lithium metal mixed oxide in the crystal structure of spinel type, wherein the metal is selected from the group consisting of cobalt, manganese, and nickel;
at least one lithium metal oxide or lithium metal mixed oxide in a crystal structure which is different from spinel type, wherein the metal is selected from the group consisting of: cobalt, manganese, and nickel;
at least one sulfur compound in the form of elemental sulfur, iron sulfide, or iron polysulfide; and
mixtures thereof.

21. A method for manufacturing an electrochemical cell according to claim 9, the method comprising:
providing at least one negative electrode including at least one material which is capable of absorbing charge carrier in the form of lithium ions during charge processes;
providing at least one positive electrode including at least one material which is capable of releasing charge carrier in the form of lithium ions during charge processes;
providing at least one electrolyte, which is capable of transporting charge carrier, in the form of lithium ions, between the at least one negative electrode and the at least one positive electrode;
providing at least one protective device, wherein the protective device is an integral part in at least one of the at least one negative electrode and the at least one positive electrode and comprises at least one enclosure, and wherein the at least one protective device is configured such that if a damaging influence in the form of heat damaging the electrochemical cell occurs, at least one stabilizing additive is released from inside the at least one enclosure; and
assembling the electrochemical cell.

22. The method according to claim 21, wherein the at least one protective device comprises at least one storage container.

23. The method according to claim 22, wherein the at least one storage container is a microcapsule.

24. The method according to claim 21, wherein the at least one stabilizing additive is a chemical stabilizing additive.

25. The electrochemical cell according to claim 21, wherein the stabilizing additive is configured to at least partially mitigate damage to the electrochemical cell caused by the damaging influence.

26. A method, comprising:
using the electrochemical cell according to claim 9 to supply energy for a load corresponding to at least one of mobile information equipment, tools, electrically driven cars, cars having hybrid drive, an automotive starting light ignition, aviation, aerospace, shipping, railed vehicles, and stationary energy storing devices.
